(19) United States
(12) Patent Application Publication
(10) Pub. No.: US 2010/0131529 A1
(43) Pub. Date: May 27, 2010

(54) OPEN ENTITY EXTRACTION SYSTEM

(76) Inventors: Vishal Kasera, San Francisco, CA (US); Stanley Chen, Mountain View, CA (US); Wojtek Skut, San Francisco, CA (US); Umesh Patil, San Jose, CA (US); Braden F. Kowitz, San Francisco, CA (US)

Correspondence Address: FISH & RICHARDSON P.C., PO BOX 1022, MINNEAPOLIS, MN, 55440-1022, US

(21) Appl. No.: 12/324,737

(22) Filed: Nov. 26, 2008

(51) Int. Cl. G06F 7/06; G06F 17/30

(52) U.S. Cl. 707/758; 707/E17.014; 707/E17.108

(57) ABSTRACT

Methods, computer program products, and systems related to providing gadgets that generate content based on entities extracted according to patterns defined by extractors are provided. A plurality of distinct extractors that define patterns for identifying entities in text are received from a plurality of users. The extractors are stored in a repository. The pattern defined by each of the extractors is processed into a pattern matching engine. The extractors are made available for subscription from a first user subscribing to a first extractor. A modification indication is received from a composition program regarding a first document of a first user, and in response to receiving the modification indication, the pattern matching engine corresponding to the first extractor is applied to the first document and identifies a first entity. The first entity is provided to a first software gadget that presents information relating to the first entity to the user.

### BACKGROUND

This invention relates to providing users with gadgets that generate content based on entities extracted according to patterns defined by extractors.

Some web-based applications and other applications provide gadgets to users that generate content based on entities extracted from search queries or documents. For example, some applications present gadgets that present content based on entities extracted from search queries. These entities are typically extracted based on either keywords in the query or a pattern that must match the entire query, rather than a more complex pattern. Some applications present gadgets that present content based on entities extracted from documents. These entities are typically extracted based on keywords in the document. While some applications may recognize more complex patterns of text, they do so only when a document is displayed and not when a document is modified.

### SUMMARY

The present disclosure provides methods, computer program products, and systems that implement techniques for providing users with gadgets that generate content based on entities extracted according to patterns defined by extractors.

In general, one aspect of the subject matter described in this specification can be embodied in a method that includes receiving from a plurality of users a plurality of distinct extractors. Each extractor defines a pattern for identifying entities in text. The extractors are stored in a repository. The pattern defined by each of the extractors is processed into a corresponding pattern matching engine. The extractors are made available for subscription by subscribing users. A subscription from a first user subscribing to a first extractor is received. A modification indication from a composition program regarding a first document of the first user is received, and in response to receiving the modification indication, the pattern matching engine corresponding to the first extractor is applied to the first document. The pattern matching engine identifies a first entity in the first document. The first entity is provided to a first software gadget that presents information relating to the first entity to the user. Other implementations of this invention include corresponding systems, apparatus, and computer program products.

These and other implementations can optionally include one or more of the following features. The first software gadget can be on a client and the first extractor can be on a server. The pattern defined by the first extractor can rely on a field in the first document. The subscription from the first user can be to a file or a feed.

Processing an extractor can include processing each extractor into a distinct pattern matching engine or processing multiple extractors into the same pattern matching engine.

The first document can be an attached document and the pattern matching engine can identify the first entity in the attached document.

An association can be created between the first user, the first extractor, and the first gadget. A subscription can be received from the first user to the first gadget.

A subscription can be received from a second user subscribing to a second extractor. An extraction request regarding a second document of the second user can be received from a presentation program. In response to receiving the extraction request, the pattern matching engine corresponding to the second extractor can be applied to the second document. The pattern matching engine can identify a second entity in the second document. The second entity can be provided to a second software gadget that presents information relating to the second entity to the user.

Context information can be received from the composition program and provided to the pattern matching engine.

In general, another aspect of the subject matter described in this specification can be embodied in a method that includes receiving from a plurality of users a plurality of distinct extractors. Each extractor defines a pattern for identifying entities in text. The extractors are stored in a repository. The pattern defined by each of the extractors is processed into a corresponding pattern matching engine. The extractors are made available for subscription by subscribing users. A subscription is received from a first user subscribing to a first extractor. An extraction request is received from a presentation program regarding a first document of the first user with an attached second document, and in response to receiving the extraction request, the pattern matching engine corresponding to the first extractor is applied to the first document. The pattern matching engine identifies the attached second document as a first entity. The first entity is provided to a first software gadget that presents information relating to the first entity to the user. Other embodiments of this aspect include corresponding systems, apparatus, and computer program products.

These and other implementations can optionally include the following feature. The attached document can be a media file and the first software gadget can be a player for the media file.

Particular embodiments of the subject matter described in this specification can be implemented to realize one or more of the following advantages. The invention allows a user to customize his experience with an application by subscribing to extractors and gadgets that provide desired extraction functionality. The invention allows a user to specify what entities will be extracted from his or her documents. The invention allows a user to select from a wide variety of extractors and gadgets developed by a number of developers.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1A illustrates a graphical user interface for an example online e-mail application displaying a document and an associated gadget that gives the user the option of adding an extracted phone number to the user's address book.

FIG. 1B illustrates a graphical user interface for an example online e-mail application displaying a document and an associated gadget that plays online video corresponding to an extracted URL.

FIG. 1C illustrates a graphical user interface for an example online e-mail application displaying a document and an associated gadget that displays a graph of stock prices associated with extracted stock symbols.

FIG. 2 illustrates an example technique for receiving extractors from a plurality of users and applying extractors to a user's document.

FIG. 3 illustrates an example architecture of a system.

FIG. 4 illustrates example information flow through a system.

FIG. 5 is a schematic diagram of a generic computer system.

### DETAILED DESCRIPTION

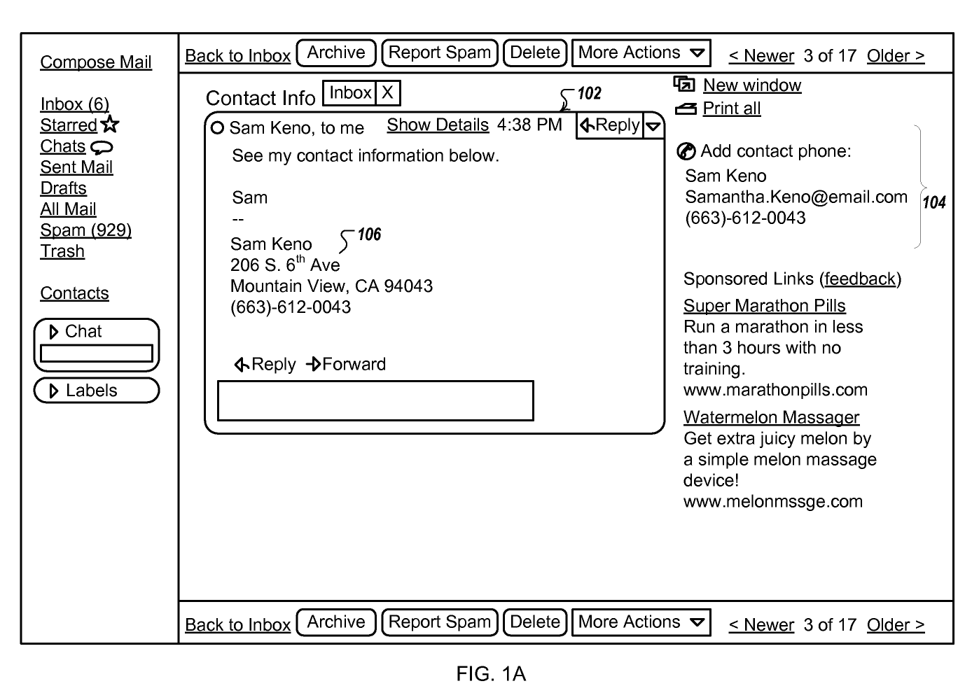

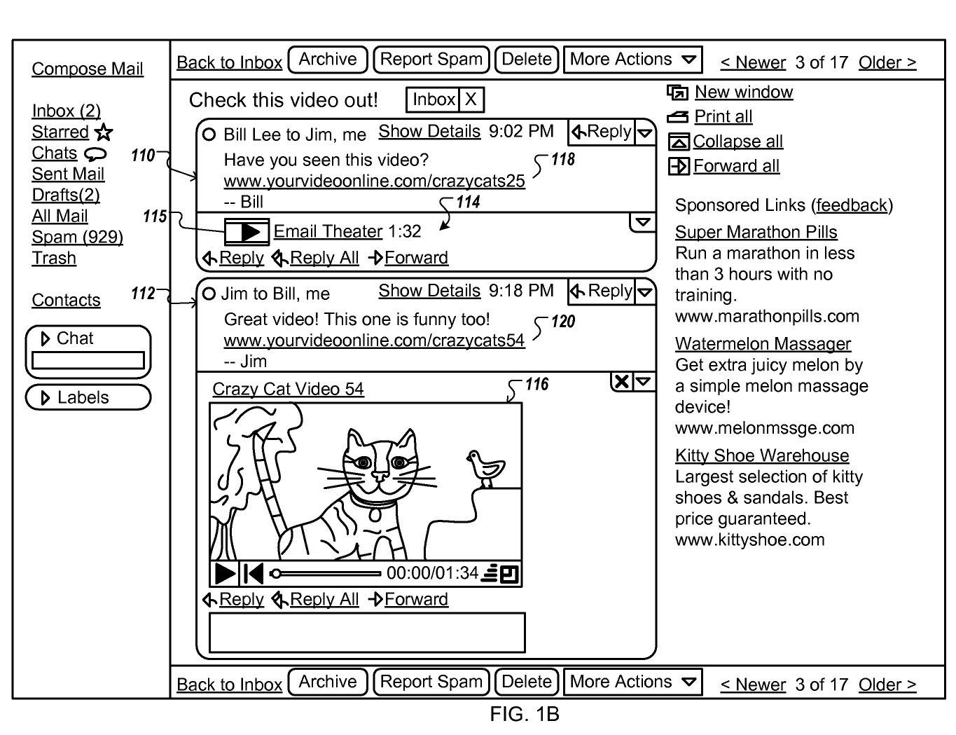

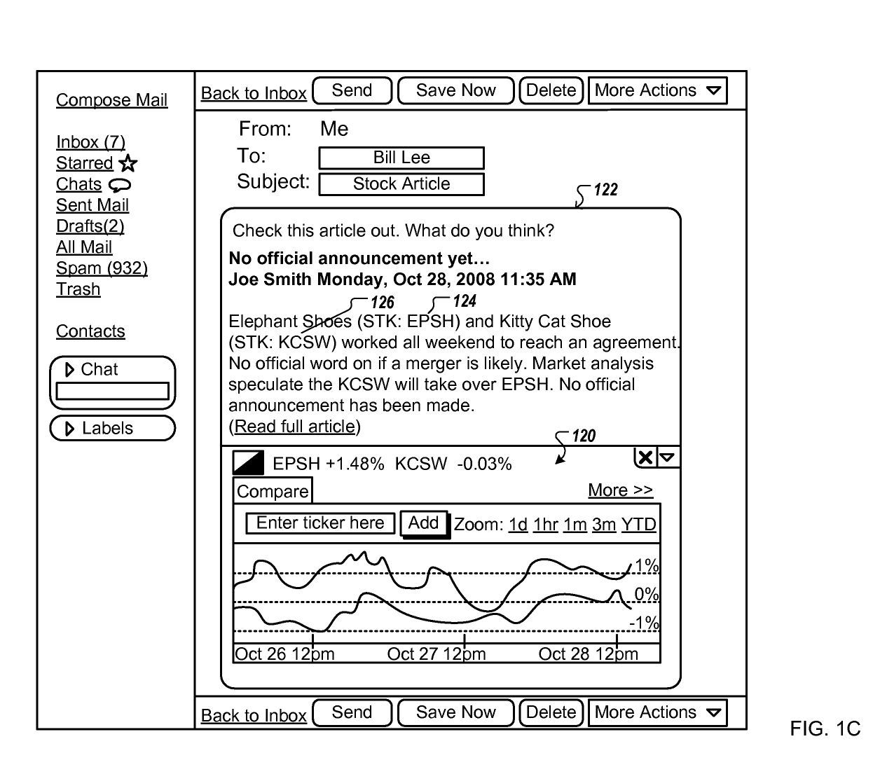

FIG. 1A illustrates a graphical user interface of an example online e-mail application displaying a document 102 and an associated gadget's output 104. Generally speaking, a gadget generates output for presentation to a user based on, or based in part on, entities gathered from a document by a pattern matching engine. A gadget can accept entities from multiple different pattern matching engines. Gadgets are usually associated with web-based applications, but can be associated with any application, for example, an application on an individual user's computer. In various implementations, an application is a computer program.

By way of illustration, a gadget associated with a web-based application executes on a server computer, and output from the gadget is transmitted through the Internet to a web browser on a client computer, for example, Google Chrome™, available from Google Inc. in Mountain View, Calif., or Firefox™, available from the Mozilla Project in Mountain View, Calif. A gadget associated with an application on an individual user's computer generally executes on the user's computer; however, it can also execute on a server computer, or partly on an individual user's computer and partly on a server computer. In various implementations, a user can select which pattern matching engines and gadgets are associated with a given application. In some implementations, a user is automatically associated with a given application and may be given the option to opt-out of the association.

Generally speaking, an extractor defines one or more patterns for identifying text in a document, recognizing a document type, or both. Application of an extractor to a document yields zero or more entities such as one or more portions of the document that satisfy the extractor's patterns. In some implementations, an extractor is processed into a pattern matching engine and the pattern matching engine processes the document. Entities identified in a document are provided to a gadget. The gadget uses these entities to present document-based content, or other content, to the user.

By way of illustration, an extractor that extracts contact information (e.g., a person's address or telephone number) and a gadget 104 that gives the user the option of adding an extracted phone number to the user's address book are associated with a user's e-mail application. The user's e-mail application displays an e-mail document 102 that includes the contact information of the sender 106. Before, when, or after the e-mail document 102 is displayed, the e-mail sender's contact information is extracted and presented by the gadget 104. The gadget 104 allows the user to add the extracted information to his or her address book.

FIG. 1B illustrates the same online e-mail program with a different gadget associated with a different extractor. In FIG. 1B an extractor that extracts a URL specifying a location of an online video and a gadget that plays online video 114 and 116 are associated with a user's e-mail application. A URL, or uniform resource locator, is an address that specifies the location of a file or a resource on the Internet. An online video is a video that can be streamed over the Internet. Online video can be hosted by individual users or specialized websites such as, for example, YouTube.

The user's e-mail program displays two e-mail documents 110 and 112. The more recently received e-mail document 112 is displayed below the older e-mail document 110. The more recent e-mail document 112 contains a URL 120 for an online video. Before, when, or after the more recent e-mail document 112 is displayed in the online e-mail program, the URL is extracted and passed to the gadget 116 which loads the online video corresponding to the URL into an online video player. The older e-mail 110 also contains a URL 118 for an online video. When the older e-mail is displayed in the online e-mail program along with the more recent e-mail, the URL 118 for an online video is extracted and passed to a gadget 114 for display to the user. Because another gadget 116 is already displaying a video, the second gadget 114 does not display the video corresponding to the extracted URL but is prepared to load the online video when the user clicks the play button 115. In other implementations, both gadgets play their corresponding online videos at the same time.

FIG. 1C illustrates the same online e-mail program associated with a different gadget, further associated with a different extractor. Here, the extractor extracts stock symbols associated with stocks traded on a stock exchange from the e-mail message, and the gadget 120 displays a graph of the stock prices of the stocks associated with the extracted stock symbols. The user's e-mail application displays an e-mail document 122 being written by the user that includes the stock symbol for Elephant Shoes “STK: EPSH” 124 and Kitty Cat Shoe “STK: KCSW” 126. Before, when, or after the e-mail document 122 is modified, the stock symbol information is extracted and sent to a gadget 120. The gadget 120 displays a graph of the stock prices corresponding to the extracted stock symbols.

A gadget is not limited to the examples above, but can generate any content for presentation to a user based on entities gathered from the document. For example, a gadget can link to a version of software code stored in a repository based on a reference in a document or generate a link to a user's profile based on a user name in a document. A gadget's presentation can include, for example, displaying output on a display device, transmitting sounds, or providing haptic feedback.

A document is not limited to an e-mail document. For example, a document can be a web page, e-mail, word processing document, spreadsheet, user profile, blog entry, or section of text. Other types of documents are possible. Moreover, a document does not necessarily correspond to a file. A document can be stored in a portion of a file that holds other documents, in a single file dedicated to the document in question, or in multiple coordinated files. Moreover, a document can be stored in a memory without first having been stored in a file.

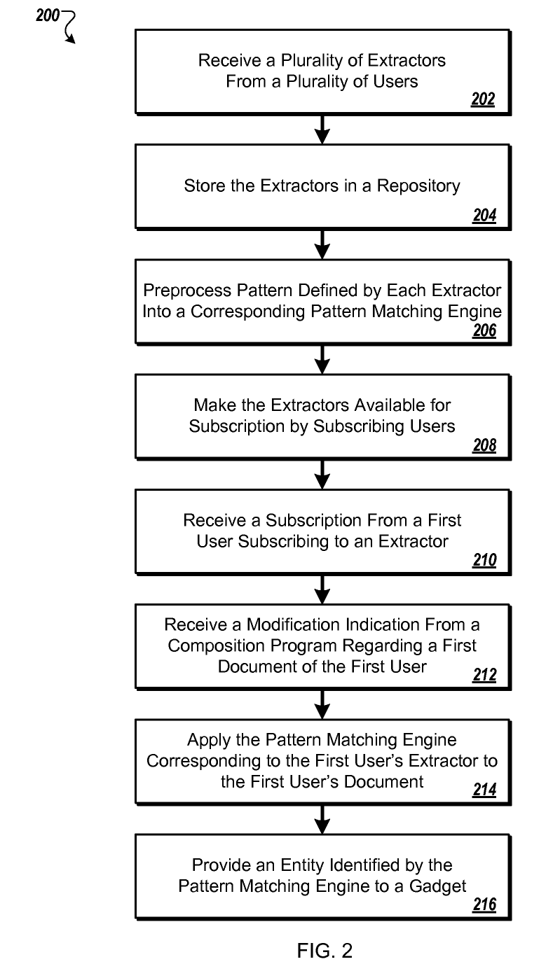

FIG. 2 illustrates an example technique 200 for receiving extractors from users and applying extractors to documents. This method can be executed, for example, by a platform provider on one or more server computers. In various implementations, a platform provider provides a system for subscribing to extractors and running pattern matching engines corresponding to extractors on user documents.

In step 202, a plurality of extractors is received from a plurality of users (e.g., by a platform provider). Extractors define patterns for identifying entities in text or patterns for identifying document content or types. Entities are, for example, pieces of text, parts of documents, whole documents, or document types. In various implementations, extractors are written in extensible markup language (XML) code; however, extractors can be in any markup language or any other form that can be interpreted by a computer.

In some implementations, extractors also contain code or a reference to another extractor that aids in or performs the extraction. In some implementations, extractors can be defined using a lexical analyzer generator, for example Lex, available on Unix computers.

In some implementations, extractors that identify entities in text use regular expressions to define a pattern for identifying entities. A regular expression is a string of text that defines a pattern for extracting one or more strings from given text. An extracted string of text is identified as an entity. Extractors that identify entities in text can also use repositories of strings when defining patterns for extracting entities. A repository of strings is a set of strings associated with a name. The set of strings can be stored in a number of ways. The name corresponding to the repository can be used in a regular expression in place of manually listing all of the strings. For example, an extractor could define a pattern to extract strings including a movie title by referencing a repository of movie titles rather than listing every movie title in the pattern. In some implementations each repository of strings has a unique name.

Here is example code for an XML extractor that extracts references to the Picasa™ photo sharing site maintained by Google Inc. of Mountain View, Calif. For example, the pattern will match on a link to a private album (such as http://picasaweb.google.com/user1/myTrip?), a link to a photo in a private album (such as http://picasaweb.google.com/user1/myTrip?1543268902454325423), a link to a video in a private album, such as http://picasaweb.google.com/user2/funParty?1432515542123455683), a link to a public album (such as http://picasaweb.google.com/user3/PublicPhotos#), a photo in a public album such as http://picasaweb.google.com/user3/PublicPhotos#4687922), a featured photo (such as http://picasaweb.google.com/user4/BestPhotos?feat=featured#4598654578913456753), a featured album (such as http://picasaweb.google.com/user4/BestPhotos?feat=featured#), a tagged photos stream (such as http://picasaweb.google.com/user5/view?feat=tags&amp;psc=G&amp;filter=1&amp;tags=trip#), a single tagged photo (such as http://picasaweb.google.com/user5/view?feat=tags&amp;psc=G&amp;filter=1&amp;tags=trip#1456774123112234789), or a recent photo (such as http://picasaweb.google.com/user6/Holidays2008?feat=recent#4245768123788746512).

```
  <?xml version=“1.0” encoding=“ISO-8859-1”?> <ExtractorData
id=“PicasaWebExtractor”>
  <AuthorInfo
    description=“Picasa extractor”
    author=“Mr. Author”
    author_email=“author@extractorsgalore.com”
    author_affiliation=“Extractors Galore”
    author_location=“Mountain View, CA, USA”
    />
  <ExtractorSpec id=“PicasaWebExtractorEnglish” platform=“gmail”
language=“en”>
    <Search>
      <Pattern>(?x)
        \b(?:http://)?(?:www\.)?picasaweb\.(?:google\.)?com/
        (?&lt;userid&gt; [\d\w\.]+)/
        (?&lt;albumid&gt; [\d\w_]+)
        ?:\?(?&lt;query_params&gt; [\w\d\-_=&amp ;]+))?
        (?:#(?&lt;photoid&gt; [\d]+)?)?
        (/|\b)
      (?-x)</Pattern>
    </Search>
    <Response platform=“application2” format=“cardgadget”>
      <Output name=“userid”>{@userid}</Output>
      <Output name=“albumid”>{@albumid}</Output>
      <Output name=“query_params”>{@query_params}</Output>
      <Output name=“photoid”>{@photoid}</Output>
      </Response>
      </ExtractorSpec>
      </ExtractorData>
```

Here is an example pattern defined in an extractor that extracts usernames. The name “user-names” is associated with a repository of strings with a string for the username of each user of the system. When this identifier is referenced in an extractor, it is used as a placeholder for all of the strings in the user names repository of strings.

<Pattern>(?x)
\b(?&lt;username&gt;(?M=user_names))\b
(?-x)</Pattern>

Extractors that identify entities in text can also rely on certain fields in the document being processed. For example, an e-mail message that is from one person to another person could have a “to” field and a “from” field specifying who the e-mail is to and from. An extractor for processing e-mail messages could then look for certain text in the “to” field or “from” field of the e-mail. An extractor can identify text in fields of a document by, for example, relying on information about the document provided by the application displaying the document.

An extractor that identifies entities in text is not limited to the functionality described above but can define a pattern for identifying entities in text in any number of ways.

Extractors that identify entities in text can also rely on context information provided by the application displaying the document. Context information is information regarding a setting of an application or use of an application. For example, an application displaying the document could provide information on who is in a user's address book. An extractor could receive this information and only extract contact information for individuals not listed in the user's address book.

An extractor that identifies types of document content identifies one or more particular types of document content. Document content refers to what type of content is stored in the document. For example, a picture file would have picture document content. A movie file would have movie document content. A document can have multiple types of content associated with it. For example, a document could store both text and pictures and thus have both text and picture content. Extractors that identify types of document content can do so in several ways including, in some implementations, analyzing the makeup of the file, header types of the file, or the filename. For example, an extractor could identify picture files by identifying whether the filename ends in an extension associated with a picture file (.JPG, .bmp, .gif, .tff, and so on). These files could be extracted and passed to a gadget that displays pictures to a user. An extractor that identifies types of document content is not limited to the examples given above, but can define a pattern for identifying types of document content in any number of ways.

In some implementations, extractors are received from a web page user interface where users upload their extractors. The web page can provide additional functionality, for example, listing extractors that a user has previously uploaded, allowing a user to delete specification files from a repository, allowing a user to modify specification files, allowing a user to download specification files from a repository, and allowing a user to distinguish between shared extractors and private extractors. Shared extractors are extractors that the user wishes to make available for subscription by other users. Private extractors are extractors the user does not want to make available for subscription by other users. The webpage can allow users other than the user who uploaded an extractor to edit or delete the extractor, for example, when the other users are affiliated with the user who uploaded the extractor. The webpage can further allow a user to specify a particular group of users who can subscribe to his or her extractor. For example, a user could allow only users within a particular domain, organization, or group to subscribe to his or her extractor. The web page may also allow users to view the status of the processing of their extractors to pattern matching engines, including whether the extractor has been processed and whether the process was a success or a failure. The webpage may also provide statistics about an extractor, such as how many gadgets are using an extractor or how many documents an extractor has processed. In other implementations, extractors are obtained from a database of preexisting extractors or a process that can generate extractors. Other techniques for obtaining extractors are also envisioned.

In one implementation, a user is required to verify his or her identity before uploading an extractor. Identity verification can include having the user enter a user name and password.

When an extractor is received, it can optionally be tested. This testing can include validating that the extractor is well-formed. A well-formed extractor is one that does not have any syntax errors. Generally speaking, a syntax error is an error in the way the extractor is written which means the extractor cannot be processed into a working pattern matching engine.

In step 204, extractors are stored in a repository (e.g. by a platform provider). The repository is a collection of extractors stored on one or more machine readable storage devices. Other data, programs, and files can be included in the repository, including, for example, pattern matching engines corresponding to one or more extractors, information about the extractor, an association between a user and an extractor, and gadgets. The repository does not have to be in a contiguous section on the machine readable storage device, nor does the repository have to be completely stored on the same machine readable storage device. In various implementations, the repository is stored on the server(s) of the platform provider. In an alternative implementation the repository is stored, at least in part, on one or more client machines.

The platform provider can also receive gadgets from users which, in some implementations, are stored in a repository much as the extractors are stored. In some implementations, a gadget and an extractor are defined in a single file or feed.

In step 206, the pattern defined by each of the extractors is processed into a corresponding pattern matching engine (e.g., by the platform provider). In some implementations, processing the pattern defined by each of the extractors into a pattern matching engine includes generating a computer program that can process a document and apply the pattern defined in the pattern matching engine to the document to extract entities from the document that match the pattern defined by the pattern matching engine. For example, a pattern matching engine could be a parser corresponding to the pattern defined by the extractor. Generally speaking, a parser processes strings of text in a document and recognizes entities corresponding to a pattern. In some implementations, processing the pattern defined by each of the extractors into a pattern matching engine includes identifying the extractor as a pattern matching engine.

Processing an extractor into a pattern matching engine can include, in some implementations, resolving one or more references in the extractor to a string repository. During extractor processing, any references to a string repository are replaced with the actual strings in the string repository.

In some implementations, extractors are processed before a pattern matching engine corresponding to the extractor is applied to the document. For example, an extractor can be processed at the time a user sends the extractor to the platform provider. Unprocessed extractors also can be processed periodically, for example, every five minutes. In some implementations, an extractor is processed at the time a user subscribes to the extractor. In yet another implementation, an extractor is processed into a pattern matching engine right before the pattern matching engine is applied to a document. Processing an extractor can be done at other times as well.

In one implementation, each extractor is processed into a distinct pattern matching engine. A distinct pattern matching engine only extracts entities that match the one or more patterns defined by its corresponding extractor. In an alternative implementation, multiple extractors are processed into the same pattern matching engine. When multiple extractors are processed into the same pattern matching engine, the pattern matching engine extracts any entity that matches any pattern defined by any of its corresponding extractors.

Combining multiple extractors into the same pattern matching engine may lead to efficiency gains by allowing the platform provider's server(s) to apply a set of patterns to a document at the same time.

Once an extractor has been processed into a pattern matching engine, the pattern matching engine corresponding to the extractor can optionally be tested (e.g., by the platform provider) to estimate the efficiency of the extractor. Estimating the efficiency of an extractor can include running the extractor on a set of sample documents, measuring the time it takes for the pattern matching engine corresponding to the extractor to process the documents, and estimating the efficiency of the extractor based on the time it took for the pattern matching engine corresponding to the extractor to process the documents. Extractors whose corresponding pattern matching engine takes longer than a pre-determined threshold may be deemed inefficient. If a pattern matching engine corresponding to an extractor is running for longer than the time specified by the threshold, the platform provider's server(s) can stop running the pattern matching engine and deem the extractor inefficient. The threshold can be determined by choosing a time a reasonable user would wait for results from the pattern matching engine.

In step 208, the extractors are made available for subscription by subscribing users (e.g., by the platform provider). This can be done in a number of ways including, for example, a web page user interface where users can view the name of available extractors and select ones the user wishes to subscribe to, or from an interface provided by an application that will request extraction by the extractor. When users view available extractors they may also be able to view additional information about the extractor, such as a description of the extractor or the author of the extractor. In some implementations, extractors are made available for subscriptions through an interface provided by an application that will be used to view or modify documents that extractors are applied to.

The subscription to an extractor can be a subscription to a file or a subscription to a feed. A file can be stored, for example, on a data processing apparatus of a platform provider, a user, or a third party. A feed is a file transferred from one data processing apparatus to another according to a protocol that allows incremental transfer of data. Examples of feed protocols include Atom feeds, RSS feeds, and GData feeds.

In an alternative implementation, gadgets can be made available for subscription by the user. Gadgets can be subscribed to separately from an extractor or can be subscribed to along with an extractor. In some implementations, gadgets are made available for subscription much as extractors are made available for subscription.

In step 210, a subscription from a first user subscribing to an extractor is received (e.g., by a platform provider). This subscription can be received in a number of ways, including, for example, through a web page interface. In some implementations, subscriptions are received through an interface provided by an application that will be used to view or modify documents that extractors are applied to.

When the subscription to the selected extractor is received, or at another time, an association can be created between the user, the selected extractor, and a gadget (e.g., by the platform provider). This association indicates that when the user views a document, the pattern matching engine corresponding to the selected extractor should be applied to the document, and any resulting entities should be passed to the gadget.

In some implementations, a subscription to one or more gadgets can also be received from a user (e.g., by the platform provider). This subscription can be received in the same ways a subscription to an extractor is received, including through a web page interface. When a user subscribes to both a gadget and an extractor, an association is made between the extractor and gadget (e.g., by the platform provider). The association indicates that entities extracted by the pattern matching engine corresponding to the extractor should be passed to the gadget. In some implementations, an extractor is associated with a gadget and when a user subscribes to an extractor the user is automatically subscribed to its associated gadget. In some implementations, a gadget is associated with an extractor and when a user subscribes to a gadget the user is automatically subscribed to its associated extractor.

In step 212, a modification indication is received from a composition program (e.g., by the platform provider) regarding a first document of a first user. The modification indication can, for example, indicate that a user is creating or modifying a document, e.g. by adding or deleting text. In some implementations, the modification indication indicates that a process is creating or modifying a document, e.g. a spell check program automatically correcting misspelled text in the document. The request can also be sent in anticipation of creation or modification of a document. In some implementations, the modification indication indicates that modification of a document is complete or has temporarily stopped.

A composition program is a computer program that displays a document and allows a user to create or edit a document. The composition program can be a web-based application, for example, an online document viewing program, an online social networking program, or any other program accessible through the Internet. Web-based applications can be, for example, javascript or actionscript programs that run in a web-browser. However, a composition program can be any application, for example, an application on an individual user's computer such as a word processor, Internet browser, or any other application run on a user's computer. In some implementations, a composition program also displays content generated by a gadget or displays the presentation component of a gadget.

In some implementations, an extraction request is received from a presentation program. The presentation program can be a web-based application, for example, an online document viewing program, an online social networking program, or any other program accessible through the Internet. Web-based applications can be, for example, javascript or actionscript programs that run in a web-browser. However, a presentation program can be any application, for example, an application on an individual user's computer such as a word processor, Internet browser, or any other application run on a user's computer. In some implementations, a presentation program also displays content generated by a gadget or displays the presentation component of a gadget. The presentation program can be a composition program.

The extraction request can, for example, indicate that user is viewing a document or be sent in anticipation of a user viewing a document. Viewing a document can include selecting a document, loading a document in an application, selecting a window that a document is already displayed in, or any other action that causes the document to be presented, partially or entirely, to the user. In some implementations, the presentation program may request extraction of multiple entities from multiple documents to generate, for example, an index of extracted entities. The extraction request is transmitted from the client computer to the server(s), for example through a hardware interface, a software interface, or through a computer network.

In step 214, the pattern matching engine(s) corresponding to the user's extractor are applied to the document (e.g., by a platform provider). Data indicating which extractor the user has subscribed to is stored and thus the appropriate pattern matching engine(s) can be identified. If a user has subscribed to multiple extractors, the pattern matching engine(s) corresponding to all extractors the user has subscribed to can be applied.

Applying the pattern matching engine corresponding to the user's extractor includes running the pattern matching engine on the document and collecting the entities extracted by the pattern matching engine. An entity extracted by a pattern matching engine can be anything from the document, including the document itself, a second document attached to the document, one or more portions of text from the document, or one or more images embedded in the document. For example, an entity could be a media file attached to the document. A media file can be, for example, a music file, a video file, or an image file. In some implementations, an entity also includes its location in the document.

In some implementations, the pattern matching engine(s) are not applied immediately after a modification indication or extraction request is received, but instead are applied later. For example, to avoid too-frequent extraction when a user is constantly modifying, a document, the pattern matching engine can be applied at discrete intervals between modification indications.

In some implementations, the pattern matching engine is run on a document attached to the document viewed by the user rather than on the document being viewed.

In some implementations, the application of the pattern matching engine is stopped if the pattern matching engine has not identified a first entity within a period of time specified by a maximum threshold. The maximum threshold can be determined, for example, by choosing a time a reasonable user would wait for results from the pattern matching engine.

In step 216, one or more entities identified by the pattern matching engine are provided to a gadget (e.g., by a platform provider).

In various implementations, a gadget generates content for display to a user based, at least in part, on entities extracted from the document. The gadget then presents this content to the user. The gadget presents the content to the user independently, alongside, or within a composition program or presentation program (whichever is displaying the document).

In some implementations, the gadget generates content for presentation to the user but relies on the composition or presentation program to present the content to the user. In these implementations the gadget can be run on either a server, in which case entities are provided to the gadget, for example, through a hardware or software interface or a network, or on a client, in which case entities are provided to the gadget through, for example, a network. A hardware or software interface is an interface that allows two programs on a machine to communicate, for example, a system bus or commands specified in an application programming interface. The gadget receives the one or more entities and uses the one or more entities to generate document-based content.

In some implementations, a gadget has two parts, a backend component that generates content for presentation to the user and a presentation component that presents content to the user and optionally interacts with the user. The presentation component is run in the composition or presentation program or alongside the composition program or presentation program.

In some implementations, both the backend component and the presentation component are run on a client machine. In these implementations, entities are passed to the gadget, for example, through a computer network.

In alternative implementations, the backend component is run on a server and the presentation component is run on a client machine. In these implementation, entities are passed to the gadget, for example, through a hardware or software interface on the server and the backend component of the gadget passes content for display to the presentation component on the client machine through, for example, a network. In some implementations, the backend component is run on a third-party server other than a server of the platform provider. In these implementations, entities are passed to the gadget, for example, through a network, and the gadget passes content for display to the presentation component on the client machine through, for example, a network.

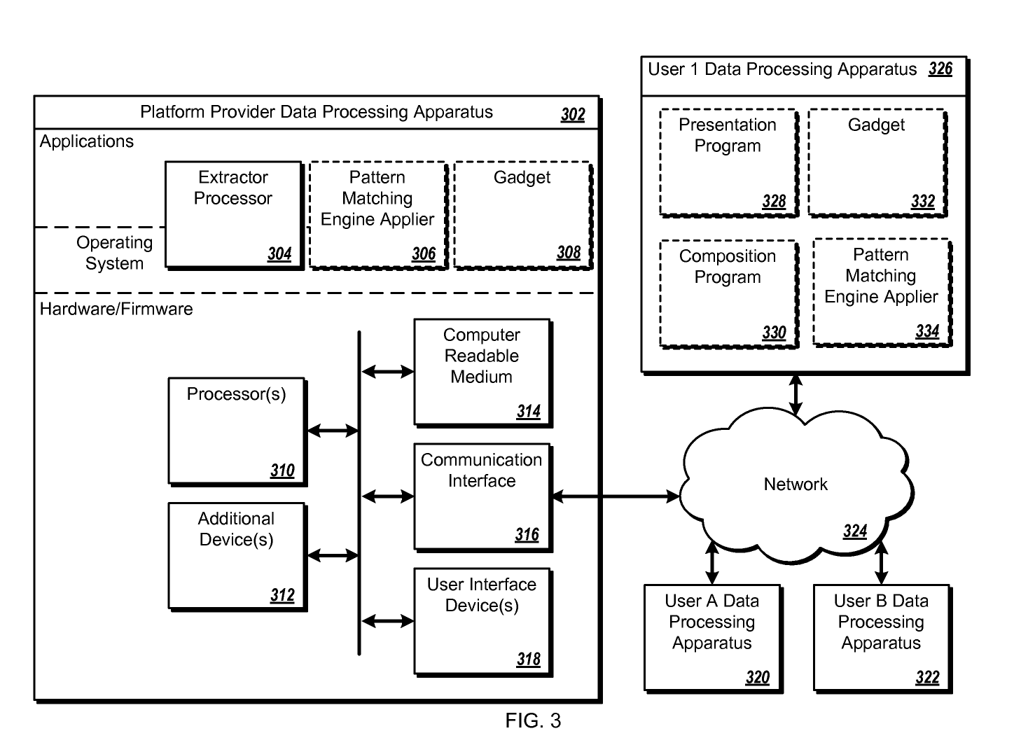

FIG. 3 illustrates an example architecture of a system. The system generally consists of a server 302, a plurality of client computers 320 and 322 used to upload extractors to the server, and a client computer 326 used to subscribe to an extractor and run a presentation program and a gadget, all connected through a network 324.

In some implementations, the client computer 326 also has the architecture of client computers 320 and 322. In some implementations, the client computers 320 and 322 also have the architecture of client computer 326.

The platform provider's server 302 is a data processing apparatus. While only one data processing apparatus is shown in FIG. 3, a plurality of data processing apparatus may be used.

In various implementations, the platform provider's server 302 runs an extractor processor program 304 and a pattern matching engine applier program 306. Running a program includes, for example, instantiating a copy of the program, providing system resources to the program, and communicating with the program through a software or hardware interface, for example, through commands specified in an application programming interface.

The extractor processor 304 processes an extractor into a corresponding pattern matching engine. Generally speaking, a pattern matching engine is a computer program that processes a document and extracts entities. In some implementations, each extractor is processed into a distinct pattern matching engine. A distinct pattern matching engine only extracts entities that match the one or more patterns defined by its corresponding extractor. In alternative implementations, multiple extractors are processed into the same pattern matching engine. When multiple extractors are processed into the same pattern matching engine, the pattern matching engine extracts any entity that matches any pattern defined by any of its corresponding extractors.

The pattern matching engine applier 306 applies a pattern matching engine to a document. This includes causing the pattern matching engine to process the document and extract entities. For example, if the pattern matching engine is a computer executable binary program, the pattern matching engine applier causes the pattern matching engine to be run by the data processing apparatus. If the pattern matching engine is software code that needs to be compiled, the pattern matching engine applier compiles the software code into a computer executable binary program and causes the binary program to be run by the data processing apparatus. If the pattern matching engine needs to be interpreted, the pattern matching engine applier interprets the pattern matching engine.

Other forms of pattern matching engines and methods of applying a pattern matching engine are also envisioned.

In some implementations, the platform provider's server 302 runs also runs a gadget program 308.

In some implementations, the gadget program 308 just generates content for display to the user. In these implementations, the gadget 308 receives extracted entities from the server 302, for example, through a hardware or software interface. The gadget 308 then generates content for presentation to the user. The content is sent to a composition program 330 or presentation program 328 on the client computer 326, for example, through the network 324.

In some implementations, the gadget 308 has two components, a backend component and a presentation component. In these implementations, the server 302 runs the backend component of a gadget 308 and the presentation component of the gadget 332 runs on the client computer 326. The backend component of the gadget receives extracted entities from the data processing apparatus, for example, through a hardware or software interface. The backend component then generates content for presentation to the user and sends the content to the presentation component of the gadget 332 on the client computer 326, for example, through a network 324, for presentation to the user.

Other implementations are envisioned. For example, in some implementations, the platform provider's server 302 runs only an extractor processor program 304. In these implementations, the pattern matching engine applier program 334 and the gadget program 332 are run on the client computer 326. In some implementations, the platform provider's server 302 runs an extractor processor program 304 and a gadget program 308. In these implementations, the pattern matching engine applier program 334 is run on the client computer 326.

In some implementations, the server 302 also stores a repository of extractors. The repository may include other programs, files, and data including pattern matching engines and gadgets. In some implementations, the repository is stored on the computer readable medium 314. In some implementations, the repository is stored on one or more additional devices 312, for example, a hard drive.

The server 302 also has hardware or firmware devices including one or more processors 310, one or more additional devices 312, computer readable medium 314, and one or more user interface devices 318. User interface devices 318 include, for example, a display, a camera, a speaker, a microphone, or a haptic feedback device.

The server 302 uses its communication interface 316 to communicate with a plurality of client computers 320, 322, and 326 through a network 324.

A plurality of client computers 320 and 322 are connected to the platform provider's server 302 through the network. Users run these computers and can write extractors using these computers. Writing an extractor can include writing software code corresponding to the extractor, for example, in a software development program or text editor run by the client computer. The client computers 320 and 322 upload completed extractors to the platform provider's server 302, for example, through the network 324.

User 1 runs a client computer 326 that is a data processing apparatus. In various implementations, the client computer 326 runs a composition program 330 and a gadget program 332.

The composition program 330 presents documents to a user and allows a user to create and modify documents, for example by adding or removing text from a document. The composition program sends a modification indication to either the platform provider's server 302 or the client computer 326 (whichever is running the pattern matching engine applier). This modification indication can be, for example, in response to a user updating or creating a document in the composition program 330 on his or her computer 326.

In some implementations, the gadget program 332 just generates content for display to the user. In these implementations, the gadget 332 receives one or more extracted entities from the server 302, for example, through the network 324. The gadget 332 generates content for display to the user based, at least in part, on the extracted entities. The gadget 332 then presents this content to the composition program 330 or the presentation program 328 for presentation to the user.

In some implementations, the gadget 332 has two components, a backend component and a presentation component, and both are run on the client computer 326. In these implementations, the gadget 332 receives one or more extracted entities from the platform provider's server 302. The backend component of the gadget generates display for presentation to the user, based at least in part on the extracted entities. The presentation component of the gadget presents the content generated by the backend component and may optionally interact with a user through the presentation program. The presentation component can be, for example, a javascript or activescript program that presents content independently, alongside, or within the composition program 330 or presentation program 328 (whichever is displaying the document). In some implementations, the presentation component of the gadget does not interact with a user and merely controls how content is presented by the presentation program.

In some implementations, the gadget has two components, a backend component and a presentation component, the presentation component of the gadget 332 is run on the client computer 326, and the backend component of the gadget 308 is run on the platform provider's server 302. In this implementation, the server sends extracted entities to the backend component of the gadget 308, for example, through a hardware or software interface. The backend component of the gadget 308 generates content for display to the user. This content is sent to the presentation component of the gadget 332, for example, through the network 324. The presentation component of the gadget 332 presents the generated content and optionally interacts with a user independently, alongside, or within the composition program 330 or presentation program 328 (whichever is displaying the document). In some implementations, the presentation component of the gadget does not interact with a user and merely controls how content is presented by the presentation program.

In some implementations, the gadget has two components, a backend component and the presentation component, the presentation component of the gadget 332 is run on the client computer 326, and the backend component of the gadget is run on a computer of a third party. In this implementation, the server sends extracted entities to the backend component of the gadget, for example, through a network. The backend component of the gadget generates content for display to the user. This content is sent to the presentation component of the gadget 332, for example, through a network. The presentation component of the gadget 332 presents the generated content and optionally interacts with a user independently, alongside, or within the composition program 330 or presentation program 328 (whichever is displaying the document). In some implementations, the presentation component of the gadget does not interact with a user and merely controls how content is presented by the presentation program.

In some implementations, the client computer 326 also runs a pattern matching engine applier program 334. The client computer 326 runs the pattern matching engine applier 334 in the same way that the platform provider's server 302 runs the pattern matching engine applier 306 in other implementations.

In some implementations, the client computer 326 runs a presentation program 328 in addition to or in place of the composition program 330. The presentation program 328 can be part of the composition program 330, or it can be a separate program. The presentation program 328 presents one or more documents to the user. The presentation program may also receive user input regarding the one or more documents and update the one or more documents or the presentation of the one or more documents based on the user input. The presentation program sends an extraction request to either the platform provider's server 302 or the client computer 326 (whichever is running the pattern matching applier), for example, when a user views a document.

Other implementations are also envisioned. For example, in some implementations, only the composition program 330 is run on the client computer 326. In these implementations, the gadget program 308 and pattern matching engine applier program 306 are run on the server 302. In some implementations only the presentation program 328 is run on the client computer 326. In these implementations, the gadget program 308 and pattern matching engine applier program 306 are run on the server 302. In some implementations, only the presentation program 328 and the composition program 330 are run on the client computer 326. In these implementations, the gadget program 308 and pattern matching engine applier program 306 are run on the server 302. In some implementations, only the composition program 330 and the pattern matching engine applier program 334 are run on the client computer 326. In these implementations, the gadget program 308 is run on the server 302. In some implementations, only the presentation program 328 and the pattern matching engine applier program 334 are run on the client computer 326. In these implementations, the gadget program 308 is run on the server 302. In some implementations, only the presentation program 328, the composition program 330, and the pattern matching engine applier program 334 are run on the client computer 326. In these implementations, the gadget program 308 is run on the server 302.

In some implementations, the client computer 326 also stores a repository of extractors. The repository may include other programs, files, and data including pattern matching engines and gadgets. In some implementations, the repository is stored on a computer readable medium. In some implementations, the repository is stored on additional devices, for example, a hard drive. In some implementations, part of the repository is stored on the server 302 and part of the repository is stored on the client computer 326.

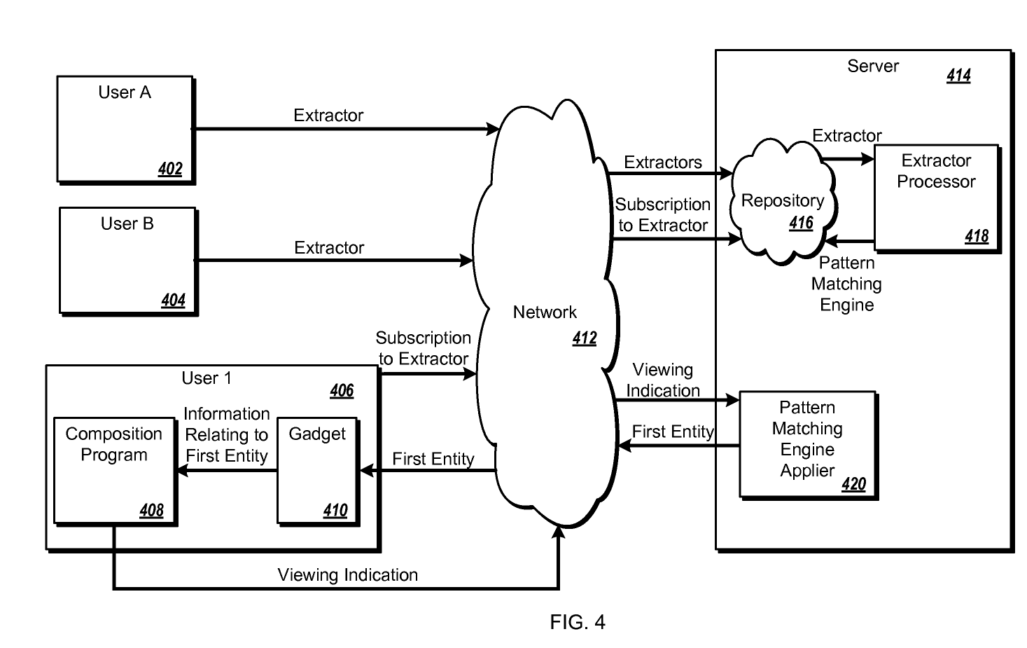

FIG. 4 illustrates information flow throughout the system in various implementations. While only one platform provider's server is shown in FIG. 4, multiple servers can also be used.

In various implementations, a plurality of user computers 402 and 404 upload extractors through the network 412 to a repository 416 stored on a platform provider's server 414. The extractors are processed into pattern matching engines by the extractor processor 418. The completed pattern matching engines are stored in the repository 416. In some implementations, gadgets are also uploaded through the network 412 and stored in a repository. In some implementations, the repository is stored, at least in part, on a client computer. In this implementation, the server 414 processes the extractor into a pattern matching engine and sends the extractor or the pattern matching engine to the repository on the client computer. In some implementations extractors are associated with gadgets. In some implementations gadgets are uploaded along with an extractor.

In various implementations, a user uses a client computer 406 to send a subscription to an extractor through the network 412 to the platform provider's server 414. The platform provider's server 414 then associates the subscribed-to extractor, or its corresponding pattern matching engine, with the user. In some implementations, a user also sends a subscription to a gadget through the network 412 to the platform provider's server 414. The platform provider's server 414 then associates the gadget with the user.

In various implementations, when the user modifies a document in a composition program 408 on a client computer 406, the client computer sends a modification indication through the network 412 to the platform provider's server 414. A pattern matching engine applier 420 then applies the pattern matching engine corresponding to a subscribed-to extractor to the document and extracts a first entity. The platform provider's server 414 then sends the first entity through the network 412 to a gadget 410 on the client computer 406. In some implementations, a presentation program runs on the client computer 406 and sends an extraction request through the network 412. In some implementations, the pattern matching engine applier is run on a client computer 406. In these implementations, the notification is sent to the client computer 406 rather than to the server 414. If the pattern matching engine and the gadget are run on the same machine, the entity can be sent to the gadget through other means, for example, a hardware or software interface.

In various implementations, the gadget 410 runs on the client computer 406, generates content relating to the first entity, and presents it to the user independently, alongside, or within a composition program 408. The content can include anything that can be presented to the user including, for example, text associated with the first entity, actions pertaining to the first entity, sound associated with the first entity, haptic feedback associated with the first entity, or javascript or activescript code defining presentation of data associated with the first entity. In some implementations, the content is presented to the user independently, alongside, or within a presentation program instead of the composition program 408. In some implementations, the gadget 410 consists of a backend component and a presentation component, and both are run on the client computer 406. The backend component receives entities from the server 414 and generates content for display. The backend component then sends the content to the presentation component which displays the content to the user and optionally updates the presentation based on interactions with the user. In some implementations, the gadget is run entirely on the server. In these implementations, the gadget generates content for display based on the extracted entities and sends this content to the client computer 406 through the network. In some implementations, the gadget consists of a backend component and a presentation component, and the backend component is run on the server 414 while the presentation component is run on the client machine 406. In these implementations, the backend component generates content based, at least in part, on the extracted entities and sends the content through the network 412 to the presentation component of the gadget on the client machine 406. The presentation component of the gadget causes the content to be presented to the user and optionally updates the presentation based on interactions with the user. In some implementations, the gadget consists of a backend component and a presentation component, and the backend component is run on a third party computer while the presentation component is run on the client machine 406. In these implementations, the backend component receives entities from the server 414 through, for example, the network and generates content based, at least in part, on the extracted entities. The content is then sent through the network 412 to the presentation component of the gadget on the client machine 406. The presentation component of the gadget causes the content to be presented to the user and optionally updates the presentation based on interactions with the user.

Additional information flows in keeping with the spirit of the invention are also envisioned.

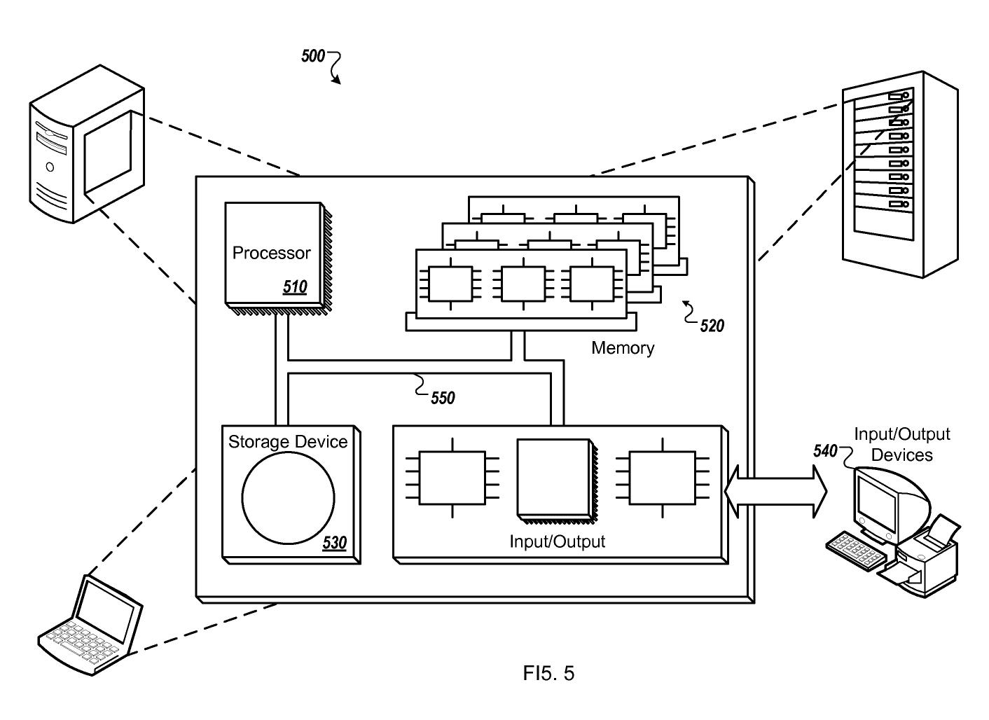

FIG. 5 is a schematic diagram of an example of a generic computer system 500. The system 500 can be used for the operations described in association with the method 200 according to one implementation. For example, the system 500 may be included in either or all of the client computer of user A, 320, the client computer of user B, 322, the client computer of user 1, 326, and the server 302.

The system 500 includes a processor 510, a memory 520, a storage device 530, and an input/output device 540. Each of the components 510, 520, 530, and 540 are interconnected using a system bus 550. Instructions that implement operations associated with the methods described above can be stored in the memory 520 or on the storage device 530. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500, including program instructions. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The storage device can store extractors, pattern matching engines, gadgets, machines, and programs.

The input/output device 540 provides input/output operations for the system 500. In one implementation, the input/output device 540 includes a keyboard and/or pointing device. In another implementation, the input/output device 540 includes a display unit for displaying graphical user interfaces.

The features described above can be implemented in digital electronic circuitry, integrated circuitry, specially designed ASICs (application specific integrated circuits), computer hardware, firmware, software, and/or combinations thereof. Various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used in this specification, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data, including databases, include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, client computer of user A, 320 and the server, 302, may be implemented within the same computer system.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer-implemented method comprising:
receiving from a plurality of users a plurality of distinct extractors, each extractor defining a pattern for identifying entities in text;
storing the extractors in a repository;
processing the pattern defined by each of the extractors into a corresponding pattern matching engine;
making the extractors available for subscription by subscribing users;
receiving a subscription from a first user subscribing to a first extractor;
receiving a modification indication from a composition program regarding a first document of the first user; and
in response to receiving the modification indication, applying the pattern matching engine corresponding to the first extractor to the first document, the pattern matching engine identifying a first entity in the first document, and providing the first entity to a first software gadget that presents information relating to the first entity to the user.

2. The method in claim 1, wherein the first software gadget is on a client and the first extractor is on a server.

3. The method in claim 1, wherein the pattern defined by the first extractor relies a field in the first document.

4. The method in claim 1, wherein the subscription from the first user is to a file or a feed.

5. The method in claim 1, wherein each extractor is processed into a distinct corresponding pattern matching engine.

6. The method in claim 1, wherein multiple extractors are processed into the same corresponding pattern matching engine.

7. The method in claim 1, wherein the first document comprises an attached document, and the pattern matching engine identifies the first entity in the attached document.

8. The method in claim 1, further comprising:
creating an association between the first user, the first extractor, and the first gadget.

9. The method in claim 1, further comprising:
receiving a subscription from the first user to the first gadget.

10. The method in claim 1, further comprising:
receiving from a second user a subscription to a second extractor;
receiving from a presentation program an extraction request regarding a second document of the second user;
in response to receiving the extraction request, applying the pattern matching engine corresponding to the second extractor to the second document, the pattern matching engine identifying a second entity in the second document, and providing the second entity to a second software gadget that presents information relating to the second entity to the user.

11. The method in claim 1, further comprising:
receiving context information from the composition program; and
providing the context information to the pattern matching engine.

12. A computer-implemented method comprising:
receiving from a plurality of users a plurality of distinct extractors, each extractor defining a pattern for identifying types of document content;
storing the extractors in a repository;
processing the pattern defined by each of the extractors into a corresponding pattern matching engine;
making the extractors available for subscription by subscribing users;
receiving a subscription from a first user subscribing to a first extractor;
receiving an extraction request from a presentation program regarding a first document of the first user with an attached second document; and
in response to receiving the extraction request, applying the pattern matching engine corresponding to the first extractor to the first document, the pattern matching engine identifying the attached second document as a first entity, and providing the first entity to a first software gadget that presents information relating to the first entity to the user.

13. The method of claim 12, wherein the attached document comprises a media file and the first software gadget comprises a player for the media file.

14. A computer program product, encoded on a computer-readable medium, operable to cause data processing apparatus to perform operations comprising:
receiving from a plurality of users a plurality of distinct extractors, each extractor defining a pattern for identifying entities in text;
storing the extractors in a repository;
processing the pattern defined by each of the extractors into a corresponding pattern matching engine;
making the extractors available for subscription by subscribing users;
receiving a subscription from a first user subscribing to a first extractor;
receiving a modification indication from a composition program regarding a first document of the first user; and
in response to receiving the modification indication, applying the pattern matching engine corresponding to the first extractor to the first document, the pattern matching engine identifying a first entity in the first document, and providing the first entity to a first software gadget that presents information relating to the first entity to the user.

15. The computer program product in claim 14, wherein the first software gadget is on a client and the first extractor is on a server.

16. The computer program product in claim 14, wherein the pattern defined by the first extractor relies a field in the first document.

17. The computer program product in claim 14, wherein the subscription from the first user is to a file or a feed.

18. The computer program product in claim 14, wherein each extractor is processed into a distinct corresponding pattern matching engine.

19. The computer program product in claim 14, wherein multiple extractors are processed into the same corresponding pattern matching engine.

20. The computer program product in claim 14, wherein the first document comprises an attached document, and the pattern matching engine identifies the first entity in the attached document.

21. The computer program product in claim 14, further operable to cause the data processing apparatus to perform operations comprising:
creating an association between the first user, the first extractor, and the first gadget.

22. The computer program product in claim 14, further operable to cause the data processing apparatus to perform operations comprising:
receiving a subscription from the first user to the first gadget.

23. The computer program product in claim 14, further operable to cause the data processing apparatus to perform operations comprising:
receiving from a second user a subscription to a second extractor;
receiving from a presentation program an extraction request regarding a second document of the second user;
in response to receiving the extraction request, applying the pattern matching engine corresponding to the second extractor to the second document, the pattern matching engine identifying a second entity in the second document, and providing the second entity to a second software gadget that presents information relating to the second entity for presentation to the user.

24. The computer program product in claim 14, further operable to cause the data processing apparatus to perform operations comprising:
receiving context information from the composition program; and
providing the context information to the pattern matching engine.

25. A computer program product, encoded on a computer-readable medium, operable to cause data processing apparatus to perform operations comprising:
receiving from a plurality of users a plurality of distinct extractors, each extractor defining a pattern for identifying types of document content;
storing the extractors in a repository;
processing the pattern defined by each of the extractors into a corresponding pattern matching engine;
making the extractors available for subscription by subscribing users;
receiving a subscription from a first user subscribing to a first extractor;
receiving an extraction request from a presentation program regarding a first document of the first user with an attached second document; and
in response to receiving the extraction request, applying the pattern matching engine corresponding to the first extractor to the first document, the pattern matching engine identifying the attached second document as a first entity, and providing the first entity to a first software gadget that presents information relating to the first entity to the user.

26. The computer program product of claim 25, wherein the attached document comprises a media file and the first software gadget comprises a player for the media file.

27. A system comprising one or more computers having software stored on a memory of the computers, the software causing the computer to perform operations comprising:
receiving from a plurality of users a plurality of distinct extractors, each extractor defining a pattern for identifying entities in text;
storing the extractors in a repository;
processing the pattern defined by each of the extractors into a corresponding pattern matching engine;
making the extractors available for subscription by subscribing users;
receiving a subscription from a first user subscribing to a first extractor;
receiving a modification indication from a composition program regarding a first document of the first user; and
in response to receiving the modification indication, applying the pattern matching engine corresponding to the first extractor to the first document, the pattern matching engine identifying a first entity in the first document, and providing the first entity to a first software gadget that presents information relating to the first entity to the user.

28. The system in claim 27, wherein the first software gadget is on a client and the first extractor is on a server.

29. The system in claim 27, wherein the pattern defined by the first extractor relies a field in the first document.

30. The system in claim 27, wherein the subscription from the first user is to a file or a feed.

31. The system in claim 27, wherein each extractor is processed into a distinct corresponding pattern matching engine.

32. The system in claim 27, wherein multiple extractors are processed into the same corresponding pattern matching engine.

33. The system in claim 27, wherein the first document comprises an attached document, and the pattern matching engine identifies the first entity in the attached document.

34. The system in claim 27, wherein software further causes the computer to perform operations comprising:
creating an association between the first user, the first extractor, and the first gadget.

35. The system in claim 27, wherein software further causes the computer to perform operations comprising:
receiving a subscription from the first user to the first gadget.

36. The system in claim 27, wherein software further causes the computer to perform operations comprising:
receiving from a second user a subscription to a second extractor;
receiving from a presentation program an extraction request regarding a second document of the second user;
in response to receiving the extraction request, applying the pattern matching engine corresponding to the second extractor to the second document, the pattern matching engine identifying a second entity in the second document, and providing the second entity to a second software gadget that presents information relating to the second entity for presentation to the user.

37. The system in claim 27, wherein software further causes the computer to perform operations comprising:
receiving context information from the composition program; and
providing the context information to the pattern matching engine.

38. A system comprising a computer having software stored on a memory of the computer, the software causing the computer to perform operations comprising:
receiving from a plurality of users a plurality of distinct extractors, each extractor defining a pattern for identifying types of document content;
storing the extractors in a repository;
processing the pattern defined by each of the extractors into a corresponding pattern matching engine;
making the extractors available for subscription by subscribing users;
receiving a subscription from a first user subscribing to a first extractor;
receiving an extraction request from a presentation program regarding a first document of the first user with an attached second document; and
in response to receiving the extraction request, applying the pattern matching engine corresponding to the first extractor to the first document, the pattern matching engine identifying the attached second document as a first entity, and providing the first entity to a first software gadget that presents information relating to the first entity to the user.

39. The system of claim 38, wherein the attached document comprises a media file and the first software gadget comprises a player for the media file.
